(19) United States
(12) Patent Application Publication
(10) Pub. No.: US 2026/0233116 A1
(43) Pub. Date: Aug. 13, 2026

(54) Internally Illuminated Toy Plush Sword

(71) Applicant: Lonme Limited, Ngau Tau Kok (HK)

(72) Inventors: Sharp Liao, Ngau Tau Kok (HK); Hyatt Liao, Ngau Tau Kok (HK); Jy Liao, Ngau Tau Kok (HK)

(21) Appl. No.: 19/050,760

(22) Filed: Feb. 11, 2025

(51) Int. Cl. A63H 33/00; A63H 5/00; A63H 33/22; F21S 4/10; F21Y 107/30; F21Y 113/13; F21Y 115/10

(52) U.S. Cl. CPC A63H 33/009; A63H 5/00; A63H 33/22; F21S 4/10; F21Y 2107/30; F21Y 2113/13; F21Y 2115/10

(57) ABSTRACT

A toy assembly having an outer shell made from plush fill that is surrounded by a fabric casing. The outer shell is cylindrical in shape, wherein an internal compartment is provided within the outer shell. Graphics can be provided on the exterior of the outer shell. A support rod and a lighting unit are positioned within the internal compartment of the plush outer shell. The lighting unit contains a string of lights and a control module. The string of lights is helically wrapped around the support rod. When activated, the string of lights illuminates a gap space between the support rod and the plush outer shell. The light from the illuminated gap space diffuses through the materials of the plush outer shell, therein internally illuminating the plush outer shell.

### BACKGROUND OF THE INVENTION

### 1.Field Of The Invention

The present invention relates to the design and manufacture of toy swords and similar constructs that are designed to be "impact safe" when used by children. The present invention also relates to the design of toy swords and similar devices that are internally illuminated.

### 2. Prior Art Description

Toy swords and similar toy weapons have been in existence throughout recorded history. Toy swords, however, are used as swords by children at play. That is, the toy sword is swung about and used to impact objects. In modern times, toy swords are increasingly made of soft materials to prevent the swords from causing any type of impact injury. In the toy industry, such soft toys are referred to as being "impact safe." Thus, toy swords are often made from light plastic or foam so that they can have structural integrity, yet lack the mass to cause any significant impact damage. If swung with enough force, a strike from a plastic sword can still cause harm, and are therefore not impact safe. Accordingly, toy manufacturers have experimented with making toy swords out of soft foam or plush. Such materials bend if moved too quickly. As a result, the toy sword often lacks the structural integrity to remain straight as the toy sword is used in play. Thus, an impact safe toy sword merely becomes a sword-shaped pillow or foam cut-out and much of the play value in the toy is greatly diminished.

The problems associated with making a toy sword too soft or too hard become compounded when the toy sword is also internally illuminated. In order to internally illuminate a toy, batteries, lights, and controls must be provided inside the toy. Such components are typically dense and hard. Thus, it is very difficult to internally illuminate a toy sword that is impact safe. The only design that has been used in the prior art is to make a hybrid toy sword that has a hard handle and a soft blade. In order to internally illuminate such a toy sword, the battery and lights are housed in the hard handle of the toy sword. The lights project light into the soft blade portion of the toy sword, therein internally illuminating the blade. Such prior art is exemplified by U.S. Patent Application Publication No. 2014/0085897 to Hakam.

Hybrid toys swords that have hard handles and soft blades may be safe if the handles are firmly held. However, if a child is using the toy sword, the toy sword can be dropped, thrown, or gripped in reverse. If gripped in reverse, hybrid toy swords become clubs. Accordingly, there is a need in the toy industry for a toy sword that has both a handle and blade that are impact safe, yet wherein the toy sword is rigid enough to maintain its shape. A need also exists for a toy sword that has both a handle and blade that are impact safe and is internally illuminated. Such needs are met by the present invention as described and claimed below.

### SUMMARY OF THE INVENTION

The present invention is a toy assembly that can configured as a sword or similar product. The toy assembly has a plush outer shell. The plush outer shell is made from plush fill that is surrounded by a fabric casing. The plush outer shell is cylindrical in shape, wherein an internal compartment is provided within the plush outer shell. Graphics can be provided on the exterior of the plush outer shell to indicate a sword or similar object.

A support rod is used to internally stiffen the outer shell. The support rod is made of flexible material that is impact safe. The support rod is positioned within the internal compartment of the plush outer shell with a lighting unit. The lighting unit contains a string of lights and a control module. The string of lights is helically wrapped around the support rod. The helical wrapping enables the support rod to bend without stressing and breaking the string of lights.

When activated, the string of lights illuminates a gap space between the support rod and the plush outer shell. The light from the illuminated gap space diffuses through the materials of the plush outer shell, therein internally illuminating the plush outer shell.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 shows an exemplary embodiment of the present invention plush assembly;

FIG. 2 shows a cross-sectional view of the exemplary embodiment shown in FIG. 1 ;

FIG. 3 shows an exploded view of the exemplar embodiment shown in FIG. 1;

FIG. 4 is an enlarged fragmented view illustrating the diffusion of light as light passes through the outer shell of the plush assembly; and

FIG. 5 is a fragmented view of the central support rod wrapped in the string of lights and showing a range of bending motion.

### DETAILED DESCRIPTION OF THE DRAWINGS

Although the present invention plush assembly can be embodied in many ways, only one exemplary embodiment is illustrated. The exemplary embodiment is being shown for the purposes of explanation and description. The exemplary embodiment is selected in order to set forth one of the best modes contemplated for the invention. The illustrated embodiment, however, is merely exemplary and should not be considered a limitation when interpreting the scope of the appended claims.

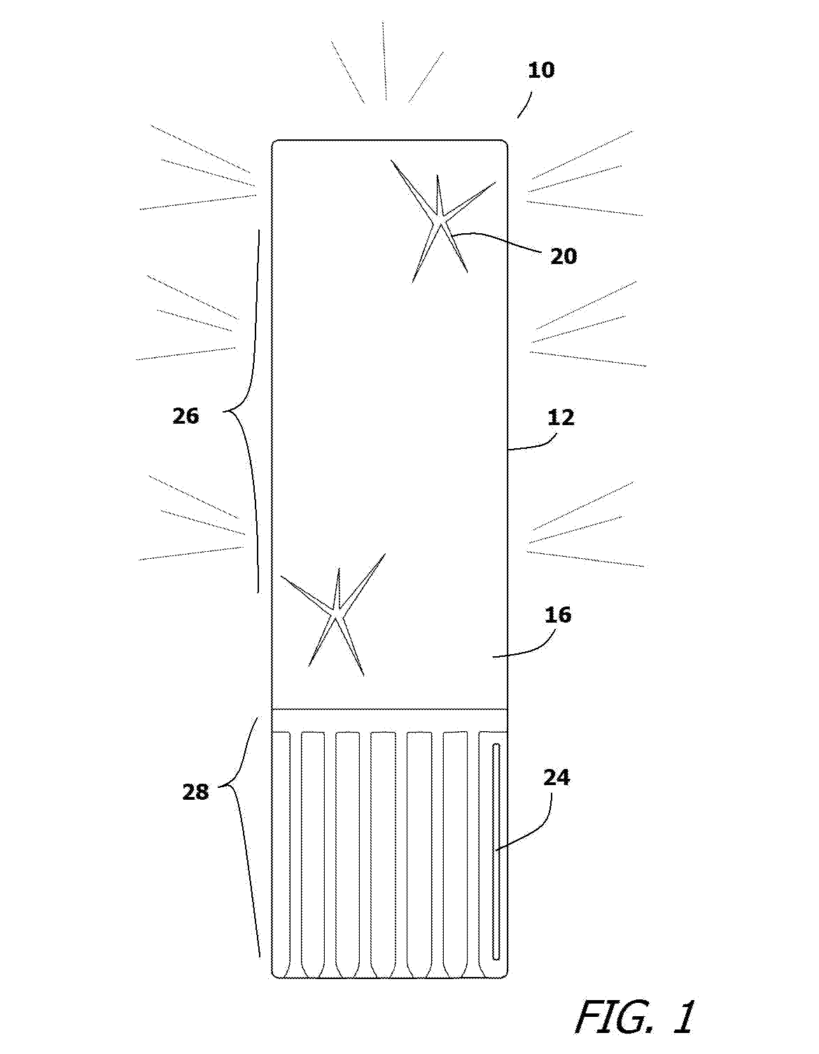

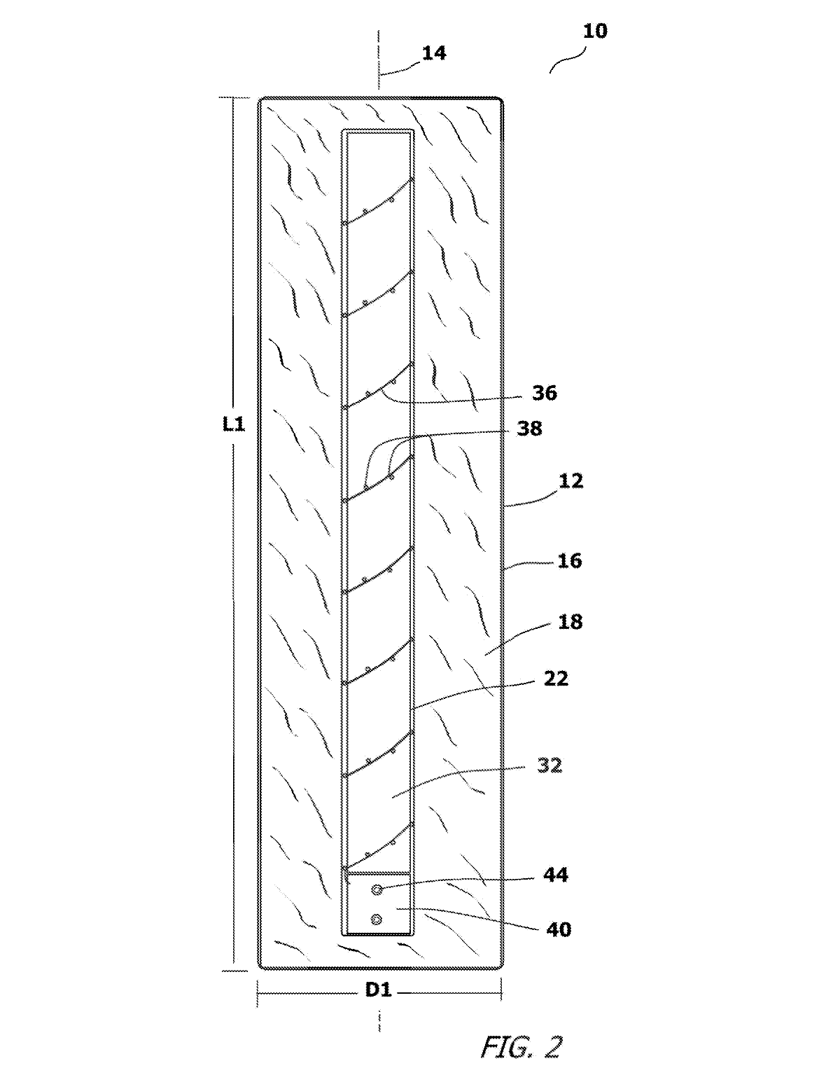

Referring to FIG. 1 in conjunction with FIG. 2, a plush assembly 10 is shown. The plush assembly 10 has an outer shell 12 that is cylindrical in shape. The outer shell 12 extends along a central axis 14 and has a length L1 that is longer than its diameter D1. The outer shell 12 has a plush construction. That is, the outer shell 12 is made from fabric casing 16 sewn over a plush fill backing 18. The plush fill backing 18 is traditional fiber fill, which is typically made of polyester fibers or puffed cotton fibers. Accordingly, the outer shell 12 is soft and is highly unlikely to cause injury if used to impact a person.

The outer shell 12 has graphics 20 printed on the fabric casing 16. The printed graphics 20 show imagery of a sword with a blade section 26 and a handle section 28. The graphics 20 can depict a traditional metal sword or a fictional weapon, such as a light saber.

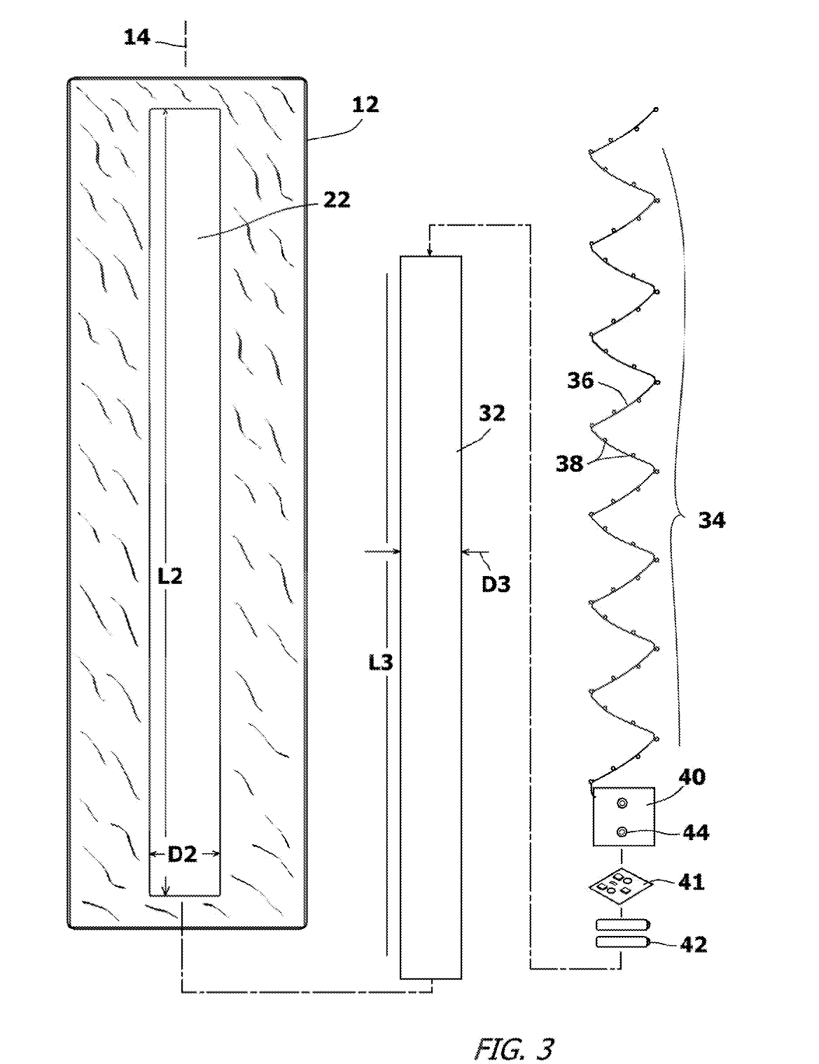

Referring to FIG. 3 in conjunction with FIG. 2 and FIG. 1, it can be seen that the outer shell 12 defines an internal compartment 22 that extends through the center of the outer shell 12 along the central axis 14. The internal compartment 22 is also cylindrical in shape and has a length L2 and a diameter D2. The internal compartment 22 is accessible through an access opening 24 that is formed in the outer shell 12. Preferably, the access opening 24 is located in the handle section 28 of the plush assembly 10. The access opening 24 preferably has a closure, such as Velcro®, a zipper, or snaps, that can keep the access opening 24 closed.

A central support rod 32 is provided. The central support rod 32 is cylindrical in shape and has a diameter D3 that is smaller than the diameter D2 of the internal compartment 22. The central support rod 32 has a length L3 that is shorter than the length L2 of the internal compartment 22. The central support rod 32 is preferably made of a plastic foam such as a polyethylene foam or a polystyrene foam. This makes the central support rod 32 both flexible and soft, yet significantly stiffer than the outer shell 12 it is internally supporting.

A lighting unit 34 is provided. The lighting unit 34 has a string of lights 36 consisting of thin wires or conductive ribbon. A plurality of LEDs 38 are positioned along the string of lights 36. At each light position along the string of lights 36, the LEDs 38 can be a single white or monochromatic LED. Alternatively, groupings of LEDs in multiple color frequencies can be provided at each light position. In this manner, LEDs 38 of different colors can be activated at different times. The string of lights 36 is long enough to helically wrap around the central support rod 32 between four and ten times.

The lighting unit 34 contains a control module 40 at the first end of the string of lights 36. The control module 40 contains batteries 42 to power the LEDs 38, circuitry 41, and buttons 44 for selectively interacting with the circuitry 41 and controlling the LEDs 38. The control module 40, in its simplest form, can turn the LEDs 38 on and off. In more sophisticated embodiments, the circuitry 41 in the control module 40 can operate the LEDs 38 in preprogrammed activation sequences and/or color sequences. Optionally, the control module 40 can also contain a speaker and audio files for producing sound effects as the various LEDs 38 are activated. The circuitry 41 in the control module 40 can also contain accelerometers and/or inclinometers that detect when the plush assembly 10 is being moved. The LEDs 38 and optional sound effects can be affected by the movements of the plush assembly 10.

The central support rod 32 is wrapped with the string of lights 36 and is inserted into the internal compartment 22 of the outer shell 12. This assembly can be done at the factory. Since the central support rod 32 is shorter than the internal compartment 22, there is room in the internal compartment 22 for the control module 40. The control module 40 is positioned within the internal compartment 22 within the handle section 28 at a position adjacent to the access opening 24. The control module 40 is accessible through the access opening 24 formed into the outer shell 12. This enables a user to manually interact with the control buttons 44 and replace the batteries 42 when needed.

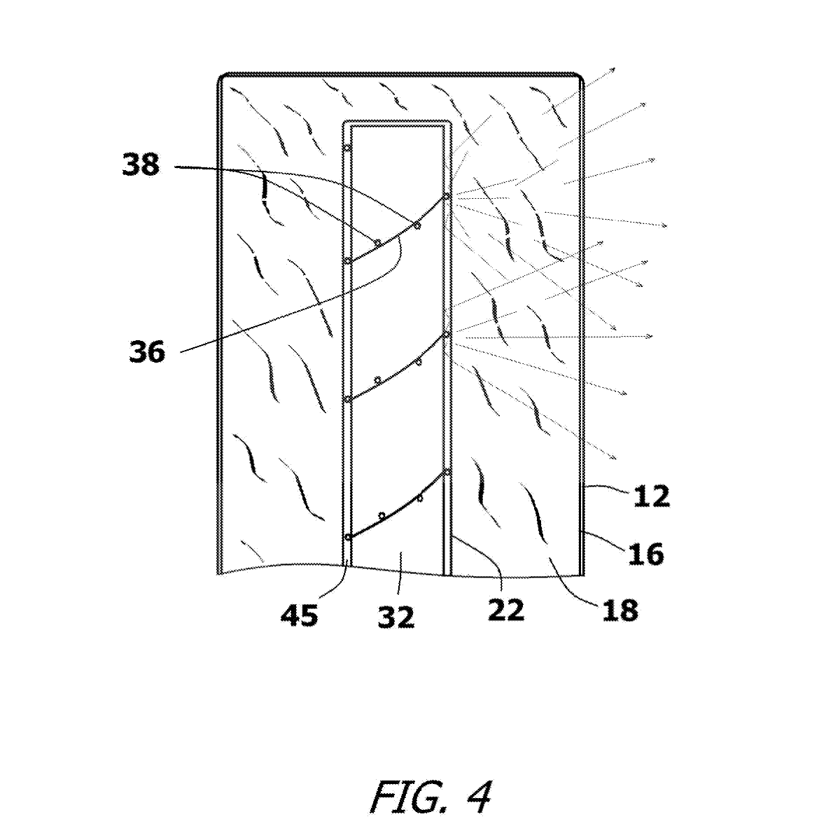

Referring to FIG. 4 in conjunction with FIG. 3, it will be understood that the central support rod 32 has a diameter D3 that is smaller than the diameter D2 of the internal compartment 22. As a result, a gap space 45 exists around the central support rod 32 within the internal compartment 22. The gap space 45 is preferably no greater than five centimeters wide. When the LEDs 38 on the string of lights 36 activate, the light illuminates the gap space 45 in between the central support rod 32 and the plush fill backing 18. The central support rod 32 is opaque, but the outer shell 12 is translucent. The density of the plush fill backing 18 and the material of the fabric casing 16 are selected so that the light produced by the LEDs 38 on the string of lights 36 can be seen through the outer shell 12. Furthermore, the plush fill backing 18 and the fabric casing 16 act as light diffusers that diffuse the light emanating from the LEDs 38. In this manner, the outer shell 12 appears to be internally illuminated in a uniform manner, rather than from point sources of light.

As has been previously stated, the string of lights 36 wraps around the central support rod 32 in a helical pattern that advances along the length of the central support rod 32. The string of lights 36 is preferably adhered to the central support rod 32 along its length or at periodic points along its length. In this manner, the string of lights 36 bends with the central support rod 32.

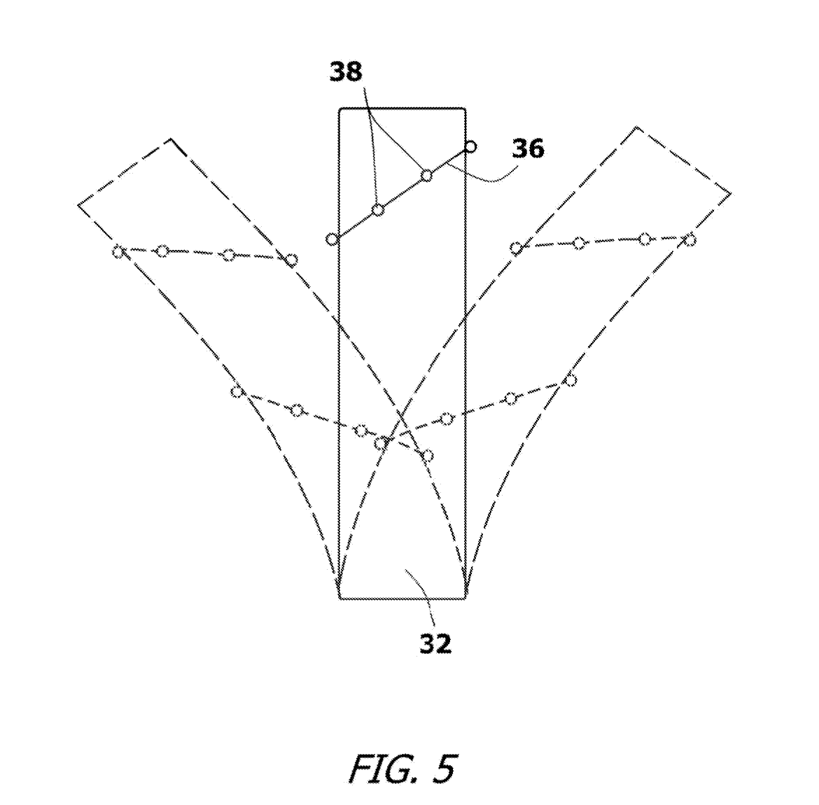

Referring to FIG. 5 in conjunction with FIG. 3, it will be understood that the helical wrapping pattern of the string of lights 36 on the central support rod 32 enables the central support rod 32 to bend in any direction. As the plush assembly 10 is manipulated and struck against objects, the outer shell 12 and the central support rod 32 bend. The helical wrapping of the string of lights 36 prevents the string of lights 36 from experiencing any significant tensile forces as the plush assembly 10 bends. Accordingly, the string of lights 36 is unlikely to break or pull away from the LEDs 38.

Furthermore, each of the LEDs 38 on the string of lights 36 is supported by the foam construction of the central support rod 32. When the plush assembly 10 is swung and impacted against a secondary object, the fabric and plush construction of the outer shell 12 cushions the impact. This prevents the internal LEDs 38 from receiving any impact damage or acceleration damage during play.

Referring to all figures, it will be understood that to use the plush assembly, the access opening 24 is temporarily opened and the control module 40 accessed. The string of lights 36 is activated and the LEDs 38 light. The LEDs 38 are helically wrapped around the central support rod 32. As the LEDs 38 activate, the light produced illuminates the gap space 45 and diffuses through the plush fill backing 18 and fabric casing 16 that form the outer shell 12. The outer shell 12, therefore, appears internally illuminated. The internal illumination makes the graphics 20 on the fabric casing 16 more noticeable. The now illuminated plush assembly 10 can then be grasped, swung, and otherwise used for play. The soft construction of the plush assembly 12 makes the plush assembly 10 safe for rough play and makes the plush assembly 10 resistant to impact damage.

It will be understood that the embodiment of the present invention that is illustrated and described is merely exemplary and that a person skilled in the art can make many variations to the embodiment. All such embodiments are intended to be included within the scope of the present invention as defined by the appended claims.

What is claimed is:

1. A toy sword assembly, comprising:an outer shell made from plush fill surrounded by a fabric casing, wherein said outer shell is cylindrical in shape having a diameter and a length that is longer than said diameter, and wherein said outer shell defines an internal compartment;graphics on said fabric casing that show a handle section and a blade section;a support rod for internally stiffening said outer shell;a lighting unit containing a string of lights and a control module, wherein said string of lights is helically wrapped around said support rod, and wherein said support rod, said string of lights and said control module are positioned inside said internal compartment of said outer shell.

2. The assembly according to claim 1, wherein said support rod is made of flexible foam.

3. The assembly according to claim 1, wherein a gap space exists between said support rod and said internal compartment of said outer shell that is illuminated by said string of lights.

4. The assembly according to claim 1, wherein said string of lights has a length and LEDs are periodically positioned along said length, wherein said LEDs produce light when activated.

5. The assembly according to claim 4, wherein said plush fill and said fabric casing are translucent to said light produced by said LEDs.

6. The assembly according to claim 4, wherein said light produced by said LEDs includes light in different color frequencies.

7. The assembly according to claim 4, wherein said string of lights is adhered to said support rod.

8. The assembly according to claim 1, wherein said control module contains circuitry for creating sound effects when said LEDs are activated.

9. A toy assembly, comprising:a plush outer shell that is cylindrical in shape and translucent to light, wherein said outer shell defines an internal compartment;a support rod disposed within said internal compartment for internally stiffening said plush outer 13 shell, wherein a gap space exists between said support rod and said plush outer shell within said internal compartment; and
a string of lights helically wrapped around said support rod within said internal compartment, wherein said string of lights illuminate said gap space with light when activated and said light diffuses through said plush outer shell to internally illuminate at least some of said plush outer shell.

10. The assembly according to claim 9, wherein said outer shell is made from plush fill surrounded by a fabric casing, wherein said outer shell is cylindrical with a diameter, and a length that is longer than said diameter.

11. The assembly according to claim 10, further including sword graphics on said fabric casing that depict a handle section and a blade section.

12. The assembly according to claim 9, wherein said support rod is made of flexible foam.

13. The assembly according to claim 9, wherein said string of lights include LEDs that are periodically positioned along a length.

14. The assembly according to claim 9, further including a control module for powering and controlling said string of lights, wherein said control module is disposed within said internal compartment.

15. The assembly according to claim 14, further including an access opening formed into said plush outer shell for accessing said control module within said internal compartment.

16. The assembly according to claim 15, wherein said control module contains circuitry for creating sound effects when said string of lights is activated.
